(19) United States
(12) Patent Application Publication
(10) Pub. No.: US 2025/0378153 A1
(43) Pub. Date: Dec. 11, 2025

(54) Age and Identity Verification System with Mobile Integration

(71) Applicant: Nick Moezidis, Henderson, NV (US)

(72) Inventor: Nick Moezidis, Henderson, NV (US)

(21) Appl. No.: 19/245,368

(22) Filed: Jun. 22, 2025

(51) Int. Cl. G06F 21/32; G06Q 50/12

(52) U.S. Cl. CPC G06F 21/32; G06Q 50/12

(57) ABSTRACT

A secure verification system enables users to confirm their age and identity before accessing a restricted device, such as a wine or beer dispenser or entry system. Upon successful verification through biometric, government-issued ID, or mobile app linkage, the system transmits a one-time access code to the user. This code can then be entered into a separate device to unlock functionality. The system is designed for use in hospitality, retail, and entertainment venues to ensure responsible and compliant access to age-restricted services.

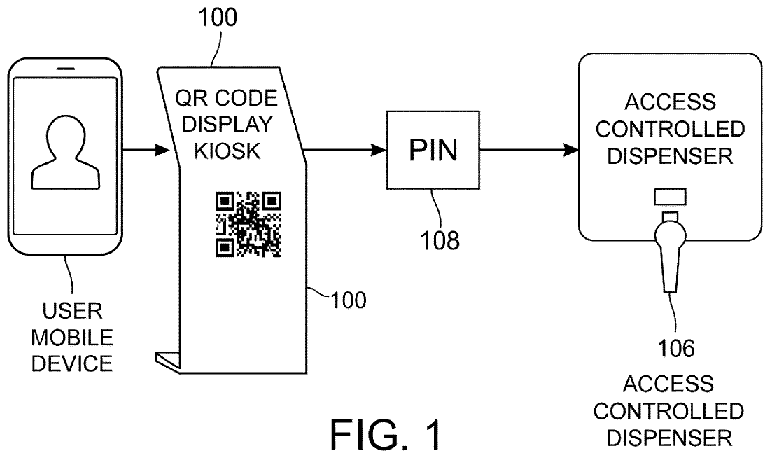

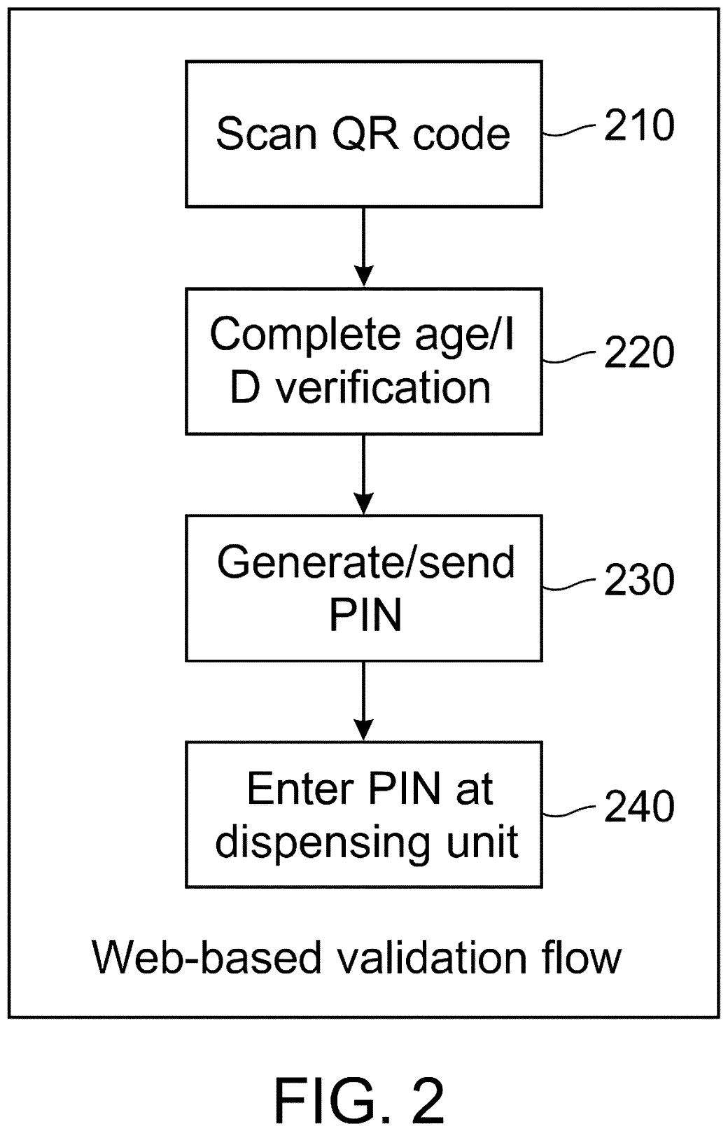

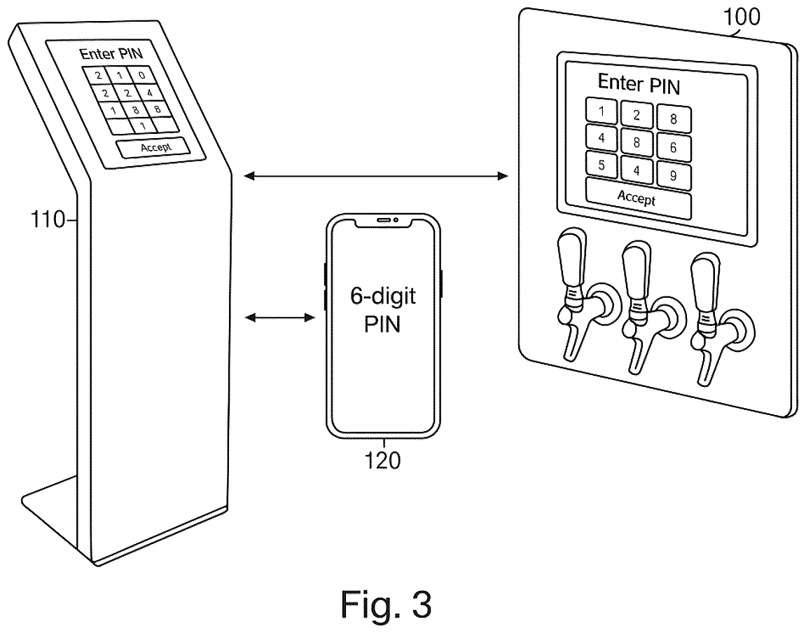

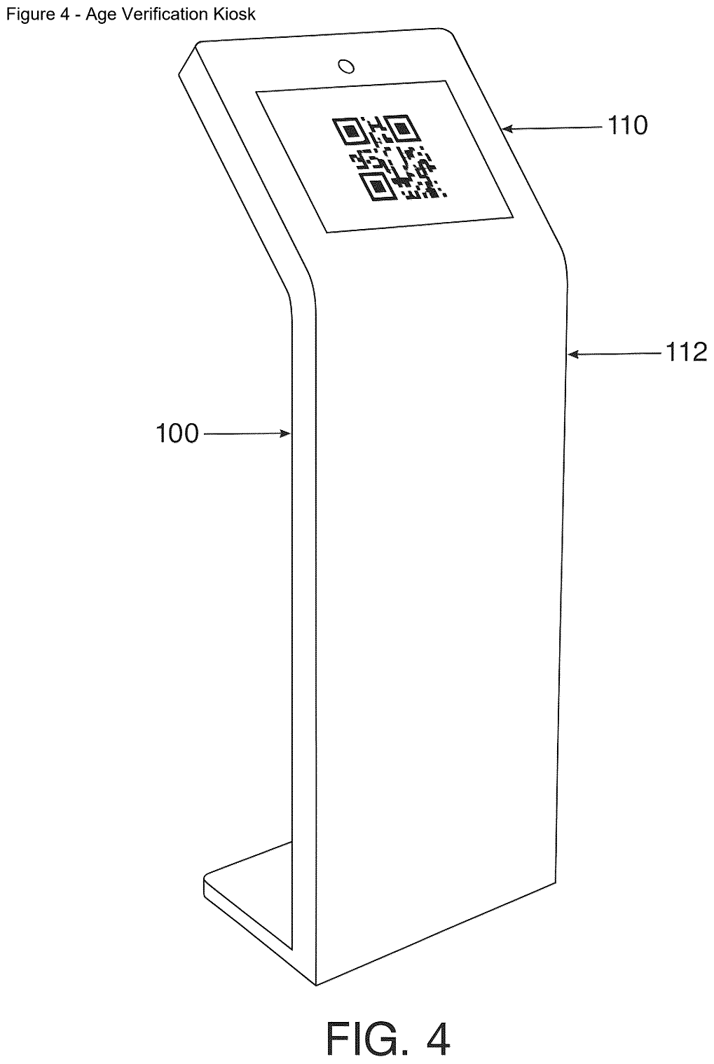

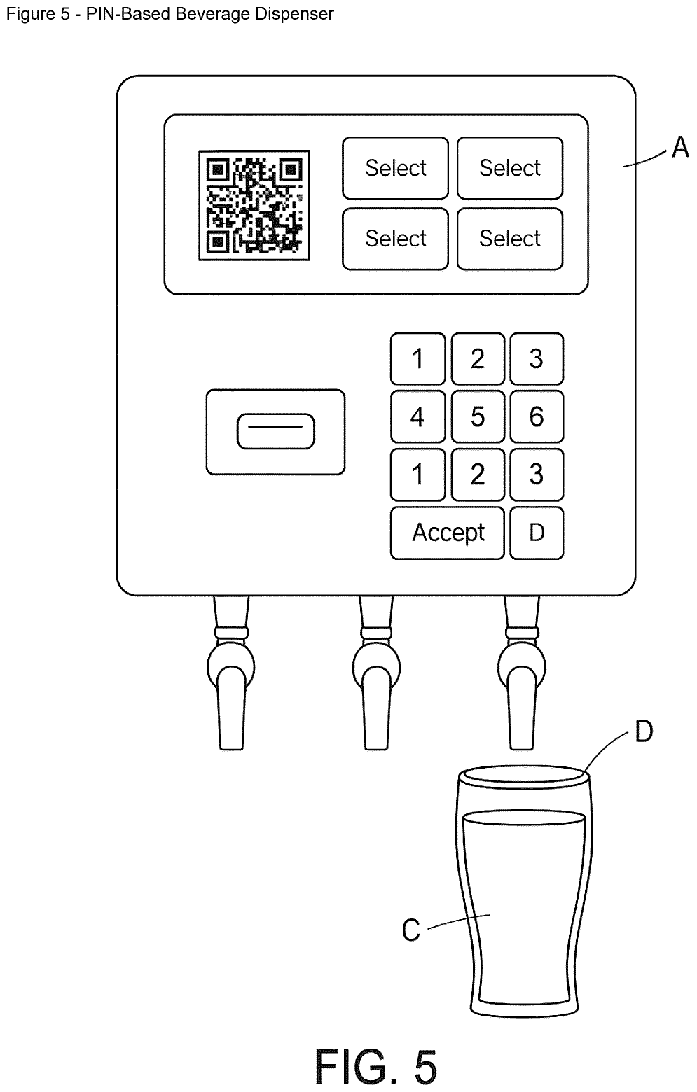

### FIELD OF THE INVENTION

This invention relates to systems and methods for validating a users age or identity and granting access to restricted areas, dispensing systems, or voting interfaces, particularly in high-throughput environments such as stadiums, entertainment venues, and polling stations.

### BACKGROUND OF THE INVENTION

Conventional access control systems perform identity verification at the point of entry or dispensing. This slows down service, especially in busy environments where waiting lines form. Additionally, these systems often rely on rigid, device-bound configurations (e.g., QR codes or PINs) that cannot flexibly adapt to user-preferred platforms or credentials. There is a need for a decoupled system where the validation process occurs upstream while the user is in line using web applications or venue mobile apps, thereby accelerating throughput and improving user experience.

### SUMMARY OF THE INVENTION

The disclosed invention enables users to complete age or identity verification using a mobile application, web interface, or venue app prior to reaching the access-controlled endpoint. Upon successful verification, a user credential (e.g., numeric PIN, alphanumeric token, digital certificate) is generated and delivered via SMS, app notification, or on-screen display. This credential is later entered into a remote device such as a wine dispenser, secure door pad, or voting kiosk to unlock access. The system also supports multiple machine-readable code types for cross-device compatibility and includes time-bound credential expiration for security.

### Claims

1. A system for validating user identity or age and enabling access to a controlled device, comprising:
a user interface comprising a display screen or machine-readable code output device;
a remote web-based application server configured to:
   initiate a verification protocol responsive to a user interaction;
   process age or identity data received from the user via a mobile device;
   generate an access credential upon successful verification;
a transmission module configured to deliver the access credential to the user via a mobile device interface, on-screen display, or messaging service;
a verification interface at a physically separate endpoint configured to receive the access credential from the user and permit or deny access to a secured dispenser, area, or terminal.

2. The system of claim 1, wherein the access credential comprises a token selected from the group consisting of: a numeric PIN, an alphanumeric string, a cryptographically signed certificate, a QR code, a barcode, an NFC tag, or a biometric signature.

3. The system of claim 1, wherein the user interface comprises a machine-readable code such as a QR code or barcode rendered on a display for scanning by the user's mobile device.

4. The system of claim 1, further comprising a timeout protocol that renders the access credential invalid after a predefined duration.

5. A method for enabling identity-based access to a controlled resource, comprising: displaying a machine-readable code to a user on a terminal or kiosk;
scanning the machine-readable code using a mobile device to initiate a remote verification process;
receiving input data from the user for verification of age or identity;
processing the verification remotely via a web server or secure endpoint;
upon successful verification, generating an access credential and delivering it to the user via a method selected from:
   on-screen display;
   SMS or messaging system;
   push notification through a mobile application;
receiving the access credential at a secondary device and validating it;
   unlocking, enabling, or granting access to a secured resource in response to successful credential validation.

6. The method of claim 5, wherein the machine-readable code comprises at least one of: QR code, barcode, near-field communication (NFC) tag, Bluetooth beacon, or device-pairing token.

7. The method of claim 5, wherein the secondary device is a dispenser, door access panel, vending system, or voting terminal.

### DETAILED DESCRIPTION/ENABLEMENT

The system described herein allows for a user to engage in an age or identity verification process through a remote interface, such as a mobile application or a web portal. A kiosk, terminal, or display generates a machine-readable code, such as a QR code, barcode, or NFC tag, which the user scans using their mobile device. This triggers a connection to a web-based application that guides the user through a secure validation process.

The process may include uploading an image of a government-issued ID, facial recognition, or answering security questions. Once validation is complete, a user credential is generated. This credential may be a numeric PIN, alphanumeric string, signed digital certificate, biometric token, or similar format. The credential is displayed to the user or transmitted via text message, email, or push notification.

At a separate physical endpoint, such as a wine or beer dispenser, door lock, vending system, or voting machine, the user inputs the credential via touchscreen, keypad, scanner, or wireless transmission. The device verifies the credential against a backend database or ephemeral validation logic and permits access only if the credential is valid and within its time window. Time-sensitive protocols are employed to prevent re-use or tampering, including credential expiry, one-time use limits, and session association.

The system is designed for high-throughput environments and reduces wait times by moving the verification process upstream. Integration with mobile applications, including those provided by venues or government entities, allows seamless experience and credential portability. The architecture supports modular endpoints and serverless or distributed backend processing to allow for broad deployment flexibility.

1. A system for verifying the age and identity of a user before granting access to a controlled device, the system comprising: a verification terminal configured to authenticate user identity through biometric data or ID scanning; a mobile communication unit operable to transmit an access code; and an access-controlled endpoint device responsive to a valid code.

2. The system of claim 1, wherein the mobile communication unit sends the access code via SMS or through a mobile application.

3. The system of claim 1, wherein the verification terminal includes a touchscreen, camera, and document scanner.

4. The system of claim 1, wherein the access-controlled endpoint is a wine, beer, or alcohol dispensing unit.

5. The system of claim 1, wherein the user's verification session is stored in a secure backend server for audit purposes.
